(19) United States
(12) Patent Application Publication
(10) Pub. No.: US 2015/0016721 A1
(43) Pub. Date: Jan. 15, 2015

(54) IMAGE-QUALITY IMPROVEMENT METHOD, APPARATUS, AND RECORDING MEDIUM

(71) Applicants: SAMSUNG ELECTRONICS CO., LTD., Suwon-si (KR); SEOUL NATIONAL UNIVERSITY R&DB FOUNDATION, Seoul (KR); SOONGSIL UNIVERSITY RESEARCH CONSORTIUM TECHNO- PARK, Seoul (KR)

(72) Inventors: Byung-Seok MIN, Seoul (KR); In-Sung HWANG, Seoul (KR); Hyung-jun PARK, Seongnam-si (KR); Sang-hwa LEE, Seoul (KR); Nam-ik CHO, Seoul (KR); Seong-wook HAN, Suwon-si (KR); Gi-bak KIM, Seoul (KR); Je-woong RYU, Suwon-si (KR)

(73) Assignees: SAMSUNG ELECTRONICS CO., LTD., Suwon-si (KR); SEOUL NATIONAL UNIVERSITY R&DB FOUNDATION, Seoul (KR); SOONGSIL UNIVERSITY RESEARCH CONSORTIUM TECHNO- PARK, Seoul (KR)

(21) Appl. No.: 14/330,579

(22) Filed: Jul. 14, 2014

(30) Foreign Application Priority Data
Jul. 12, 2013 (KR) 10-2013-0082467

(51) Int. Cl. G06T 7/40; G06K 9/40; G06K 9/00

(52) U.S. Cl. CPC G06T 7/408; G06K 9/00234; G06K 9/40; G06T 2207/20182; G06T 2207/20172; G06T 2207/30168
USPC 382/167

(57) ABSTRACT

An image-quality improvement method is provided. The image-quality improvement method includes detecting an area of interest from an input image; generating a color distribution map based on a plurality of respective brightness elements and a plurality of respective chroma elements of a plurality of pixels which belong to a predetermined color series and which are in the detected area of interest of the input image; determining a first area, which belongs to the predetermined color series, and a second area, which is an area of the input image other than the first area, according to the color distribution map; and changing values of a plurality of pixels in at least one of the first area and the second area.

### RELATED APPLICATIONS

This application claims priority from Korean Patent Application No. 10-2013-0082467, filed on Jul. 12, 2013, in the Korean Intellectual Property Office, the disclosure of which is incorporated herein in its entirety.

### BACKGROUND

1. Field

Exemplary embodiments relate to an image-quality improvement method. In particular, exemplary embodiments relate to a method of improving image quality by determining pixels that have similar characteristics in an image, and executing an image processing process on the determined pixels.

2. Description of the Related Art

As advancements in image-acquiring technology display apparatuses have occurred, there is an increasing demand for high-quality image acquiring technology. As a method of acquiring a high-quality image, research has occurred for developing a method of executing an image processing process on pixels located in partial areas of an image that have similar characteristics, instead of on the entire image. As an example, research is being conducted for developing a method of determining areas that have similar colors, based on colors of pixels that constitute an image.

Therefore, in a related art, when similar color elements are found in an image, characteristics of the image with respect to the similar color elements are not considered. Thus, in the related art, it may be difficult to ensure accuracy when determining an area of an image to be processed.

### SUMMARY

Exemplary embodiments may include a method, an apparatus, and a recording medium for improving image quality by determining partial areas that have similar characteristics in an image, and executing an image processing process on the determined partial areas.

Additional aspects will be set forth in part in the description which follows and, in part, will be apparent from the description, or may be learned by practice of the presented embodiments.

According to an aspect of the exemplary embodiments, an image quality improvement method includes: detecting an area of interest from an input image; generating a color distribution map based on a plurality of respective brightness elements and a plurality of respective chroma elements of a plurality of pixels which belong to a predetermined color series and which are in the detected area of interest of the input image; determining a first area, which belongs to the predetermined color series, and a second area, which is an area of the input image other than the first area, according to the color distribution map; and changing values of a plurality of pixels in at least one of the first area and the second area.

According to an aspect of the exemplary embodiments, an image quality improvement apparatus includes: a detector which is configured to detect an area of interest from an input image; a generator which is configured to generate a color distribution map based on a plurality of respective brightness elements and a plurality of respective chroma elements of a plurality of pixels which belong to a predetermined color series and which are in the detected area of interest of the input image; a determinator which is configured to determine a first area, which belongs to the predetermined color series, and a second area, which is an area of the input image other than the first area, according to the color distribution map; and a changer which is configured to change values of a plurality of pixels in at least one of the first area and the second area.

### BRIEF DESCRIPTION OF THE DRAWINGS

These and/or other aspects of the exemplary embodiments will become apparent and more readily appreciated from the following description of the embodiments, taken in conjunction with the accompanying drawings in which:

FIG. 1 is a conceptual image for explaining an image-quality improvement method according to an embodiment;

FIG. 2 is a block diagram of an image quality improvement apparatus according to an embodiment;

FIG. 3 is a block diagram of a generation unit included in the image quality improvement apparatus according to an embodiment;

FIG. 4 is a block diagram of a determination unit included in the image quality improvement apparatus according to an embodiment;

FIG. 5 is a block diagram of a change unit included in the image quality improvement apparatus according to an embodiment;

FIG. 6 is a flowchart for explaining an image-quality improvement method according to an embodiment;

FIG. 7 is a diagram for explaining a process of detecting a skin color area in an input image according to an embodiment;

FIG. 8 is a flowchart for explaining the image-quality improvement method according to an embodiment;

FIG. 9 is a detailed flowchart for explaining generating a color distribution map included in the image-quality improvement method according to an embodiment; and

FIG. 10 is a detailed flowchart for explaining determining each area in an input area according to an embodiment.

### DETAILED DESCRIPTION OF EXEMPLARY EMBODIMENTS

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the exemplary embodiments. Any modifications, variations or replacement that may be easily derived by those skilled in the art from the detailed description and the present embodiments should fall within the scope of embodiments of the exemplary embodiments. As used herein, the term “and/or” includes any and all combinations of one or more of the associated listed items. Expressions such as “at least one of,” when preceding a list of elements, modify the entire list of elements and do not modify the individual elements of the list.

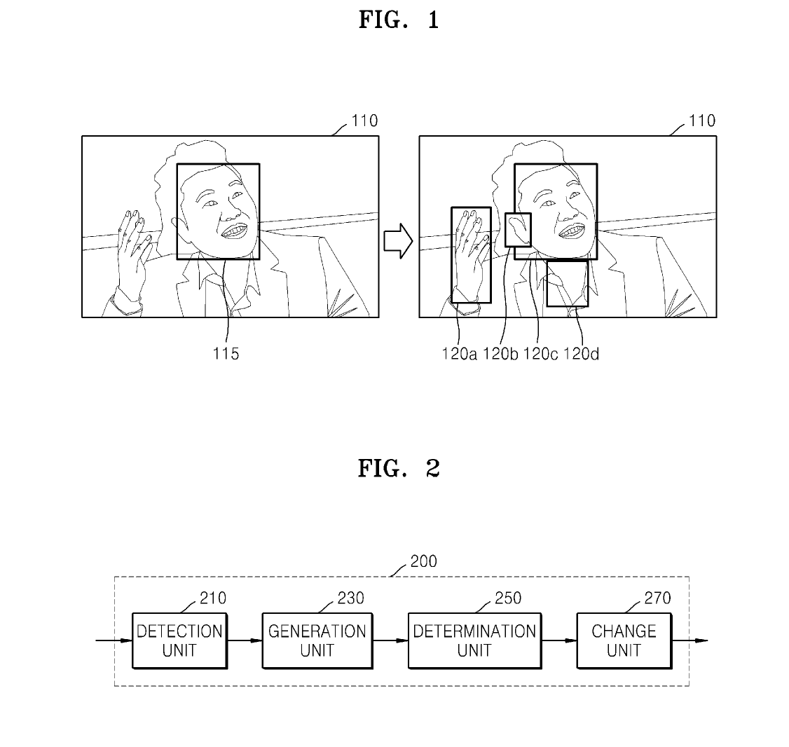

FIG. 1 is a conceptual image for explaining an image-quality improvement method according to an embodiment.

Referring to FIG. 1, an area of interest 115 may be detected to determine a plurality of first areas 120a through 120d, which belong to a certain color series, in an input image 110. The area of interest 115 may be an area that includes color information which is associated with a plurality of areas to be determined in the input image 110. In particular, by using pixels that have a color belonging to the certain color series and that are extracted from the area of interest 115, an area which has a color that belongs to the certain color series may be determined in the input area 110.

A color distribution map may be generated based on a brightness element and a chroma element. It may be determined whether each pixel constituting the input image 110 is included in a certain color series, based on the generated color distribution map. According to an exemplary embodiment, probability information, which shows the possibility of whether a color of respective pixels in the input image 110 will be included in a certain color series, may be generated based on the color distribution map.

According to the generated color distribution map, a first area that is included in a certain color series, and a second area that is an area other than the first area may be determined. If probability information of a pixel is equal to or higher than a preset reference value, it may be determined that the pixel will be included in the first area. In contrast, if probability information of a pixel is less than a preset reference value, it may be determined that the pixel will be included in the second area.

Values of pixels in at least one of the determined first and second areas may be changed. A method of changing a value of pixels may include, for example, a process of adjusting a strength of contrast, a process of sharpening an edge by enhancing detail, a process of adjusting color saturation, and a process of removing noise.

According to an exemplary embodiment, the area of interest 115 may be a face area of a person. If the area of interest 115 is a face area of a person, a color distribution map according to skin color may be generated from a detected face area, and thus, the first areas 120a through 120d, which are included in the color distribution map, may be determined from the input image 110.

In particular, according to an exemplary embodiment, pixels that are included in a skin color series may be extracted from a face area that is the area of interest 115. Color information regarding a skin color series may be provided from preset data regarding a skin color or pixels that are located at a center of the area of interest 115. A method of receiving color information about a skin color series will be described by referring to FIG. 2.

A color distribution map may be generated based on a brightness element and a chroma element of each of the extracted pixels. It may be determined whether each pixel that constitutes the input image 110 is included in a color series, based on the generated color distribution map. As an example, based on the color distribution map, the probability of whether each pixel that constitutes the input image 110 will belong to in a skin color series may be expressed as probability information. If probability information of a pixel is equal to or higher than a preset reference value, it may be determined that the pixel is expected to belong to the skin color series. In contrast, if probability information of a pixel is less than a preset reference value, it may be determined that the pixel is not expected to belong to the skin color series.

Pixels in the input image 110 which are determined to belong to the skin color series, may be included in the first areas 120a through 120d, and pixels in the input image 110 which are determined not to belong to in the skin color series may be included in the second area.

FIG. 2 is a block diagram of an image quality improvement apparatus 200 according to an exemplary embodiment.

Referring to FIG. 2, the image quality improvement apparatus 200 may include a detection unit 210 (e.g., “detector”), a generation unit 230 (e.g., “generator”), a determination unit 250 (.e.g,, “determinator”), and a change unit 270 (e.g., changer“).

The image quality improvement apparatus 200, shown in FIG. 2, includes only elements related to the current embodiment. However, it will be understood by those skilled in the art that general use elements, other than the elements shown in FIG. 2, may be further included in the image quality improvement apparatus 200.

The detection unit 210 may detect the area of interest 115 from the input image 110. The area of interest 115 may be an area that includes color information regarding areas to be determined in the input image 110.

According to an exemplary embodiment, the area of interest 115 may be a face area of a person. A case in which the area of interest 115 is a face area of a person is described below. However, the case in which the area of interest 115 is a face area of a person is just an exemplary embodiment, and the exemplary embodiments are not limited thereto.

According to an exemplary embodiment, a method of detecting a face area using the detection unit 210 is not limited to a specific detection technology. As an example, the detection unit 210 may detect a face area by using a face detection technology with a two-dimensional (2D) Haar filter.

The generation unit 230 may generate a color distribution map based on brightness elements and chroma elements of pixels belonging to a specific color series in the face area that is detected by the detection unit 210. However, this is only an embodiment, and a specific color series is not limited to a skin color series. A specific color series may be determined as a color of an object to be detected.

Hereinafter, according to an exemplary embodiment, a description is provided in a case in which a certain color series is a skin color series.

The generation unit 230 may extract pixels belonging to a skin color series from the detected face area. In particular, the generation unit 230 may select a pixel belonging to a skin color series of a defined skin color from a center of a face area and extract pixels that belong to that same skin color series and are distributed in the face area by applying a flood-fill method to the selected pixel.

Additionally, the generation unit 230 may collect a defined skin-color model or a skin color image in order to extract pixels in the skin color series from the detected face area. The generation unit 230 may extract a pixel which has a color included in the skin-color model, from pixels in the detected face area. If the pixels in the skin-color series are extracted, pixels which include a color that is different from a general skin color such as an eye color or a hair color may be easily excluded from the face area.

The generation unit 230 may convert a color element of the extracted pixels into a YCbCr space, which is a color space according to a brightness element and a chroma element. Y refers to a brightness element, Cb refers to a blue chroma element, and Cr refers to a red chroma element. In the YCbCr space, a coordinate of the extracted pixel may be obtained with regard to Cb having a value of Y as a variable (in a Y-Cb plane) and Cr having a value of Y as a variable (in a Y-Cr plane) for a color element of the extracted pixels.

A form in which coordinates of the extracted pixels are distributed in the Y-Cb plane may be expressed as a function in which Y is a variable. Additionally, a form in which coordinates of the extracted pixels are distributed in the Y-Cr plane may be expressed as a function in which Y is a variable. The function may be a polynomial function, a rational function, or a trigonometric function. A color distribution map with regard to the extracted pixel may be generated by defining a difference between the function expressed in the Y-Cb plane and the function expressed in the Y-Cr plane as a new variable.

According to an exemplary embodiment, by generating a color distribution map in consideration of a brightness element, a pixel in a skin color series may be extracted from the input image in consideration of an effect of the brightness element on a chroma element. For example, if a skin color in a face area greatly changes due to lighting, a color distribution map is generated only in consideration of a chroma element. Therefore, a pixel in a skin color series may not be accurately extracted from the face area. In contrast, according to an exemplary embodiment, the generation unit 230 may generate a color distribution map for accurately extracting a pixel in a skin color series in consideration of a brightness element.

According to an exemplary embodiment, data may be generated, which may determine whether pixels in the input image area belong to a color series based on a color distribution map. As an example, a probability value may be used to express whether respective pixels that constitute the input image 110 belong to a color series, based on a color distribution map.

The determination unit 250 may determine a first area that is included in a skin color series and a second area that is an area other than the first area, in the input image 110, based on the color distribution map generated by the generation unit 230. The first area and the second area may be determined using a probability value that shows whether pixels belong to a skin color series.

In particular, if a probability value of a pixel is equal to or higher than a preset reference value, it may be determined that the pixel is in the first area and that the first area is a skin area. In contrast, if a probability value of a pixel is less than a preset reference value, it may be determined that the pixel is in the second area and that the second area is an area other than the skin area.

The determination unit 250 may equalize each area of the first area and the second area. Therefore, a high-frequency element is reduced. Further, the determination unit 250 may remove noise in each area using a median filter, a bilateral filter, or using another method such as dilation, erosion, opening or closing of morphology.

The change unit 270 may change values of pixels in at least one of the first area and the second area. With regard to the at least one of the first area and the second area, the change unit 270 may perform at least one process among a process of adjusting a strength of contrast, a process of sharpening an edge, a process of adjusting color saturation, and a process of removing noise. The processes may be independently performed for each frame of an image, and a strength of a process may be adjusted for each frame.

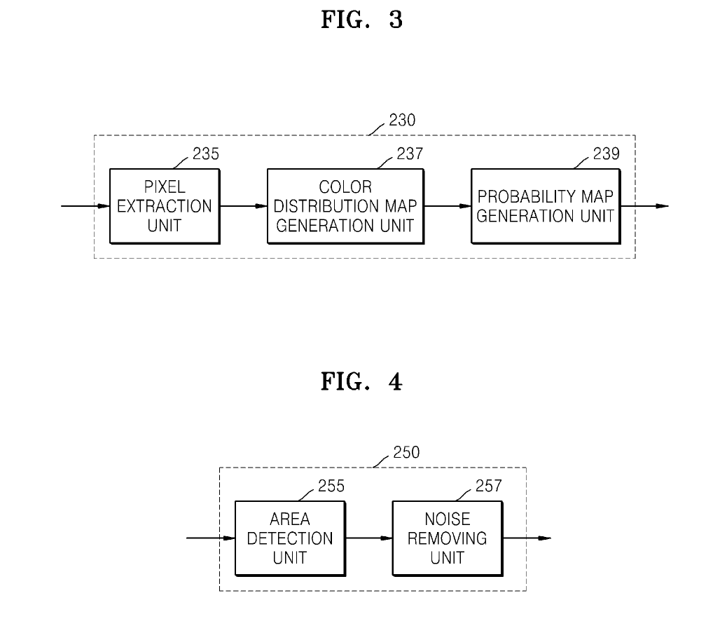

FIG. 3 is a block diagram of the generation unit 230 included in the image quality improvement apparatus 200 according to an exemplary embodiment.

Referring to FIG. 3, the generation unit 230 included in the image quality improvement apparatus 200 may include a pixel extraction unit 235, a color distribution map generation unit 237, and a probability map generation unit 239.

As shown in FIG. 3, the generation unit 230 included in the image quality improvement apparatus 200 includes only elements related to the current embodiment. However, it will be understood by those skilled in the art that general use elements other than the elements shown in FIG. 3 may be further included in the generation unit 230.

The pixel extraction unit 235 may extract pixels belonging to a skin color series from the face area that is detected by the detection unit 210. According to an exemplary embodiment, the pixel extraction unit 235 may select a pixel belonging to a series of a defined skin color from a center of a face area and extract pixels that belong to that same skin color series and are distributed in the face area, by applying a flood-fill method to the selected pixel.

The pixel extraction unit 235 may extract pixels belonging to the skin color series from the face area that is detected based on a defined skin-color model or a skin color image. For example, the pixel extraction unit 235 may extract a pixel which has a preset skin color, from pixels that constitute the detected face area.

The color distribution map generation unit 237 may convert a color element of the pixels, which are extracted by the pixel extraction unit 235, into a YCbCr space, which is a color space according to a brightness element and a chroma element. In the YCbCr space, a coordinate of the extracted pixel may be obtained, with regard to Cb having a value of Y as a variable (in a Y-Cb plane) and Cr having a value of Y as a variable (in a Y-Cr plane) for a color element of the extracted pixels.

A form in which coordinates of the extracted pixels are distributed in the Y-Cb plane may be expressed as a function in which Y is a variable. Additionally, a form in which coordinates of the extracted pixels are distributed in the Y-Cr plane may be expressed as a function in which Y is a variable.

By defining a difference between a function which is expressed in the Y-Cb plane and a function which is expressed in the Y-Cr plane as a new variable, a color distribution map for the extracted pixel may be generated. If it is assumed that fb(y) is a function that is obtained for a Cb element and fr(y) is a function that is obtained for a Cr element, a probability variable for a difference value for the Cb element in each Y-Cb coordinate, and a probability variable for a difference value for the Cr element in each Y-Cr coordinate may be derived from Equation 1 shown below.

fb(Y)−Cb(Y)=Xb(Y),

fr(Y)−Cr(Y)=Xr(Y) [Equation 1]

If it is assumed that two probability variables Xb(Y) and Xr(Y) have an associative distribution, Xb(Y) and Xr(Y) may be expressed as one probability distribution function. Accordingly, an average, a covariance, and respective standard deviations of Xb(Y) and Xr(Y) may vary according to a value of Y. According to an exemplary embodiment, one probability distribution function may be derived as Equation 2, shown below.

$$P ( Xb ( Y ) , Xr ( Y ) ) = \frac{{\vert {R}^{- 1} \vert}^{\frac{1}{2}}}{2 π} exp \{ - \frac{{[ X - \overline{X} ]}^{T} {R}^{- 1} [ X - \overline{X} ]}{2} \} , \\ [ X - \overline{X} ] = [ \begin{matrix}Xb ( Y ) - \overline{Xb} ( Y ) \\ Xr ( Y ) - \overline{Xr} ( Y )\end{matrix} ] \qquad [ Equation 2 ]$$

Referring to Equation 2, |IR⁻¹| may mean a determinant for an inverse matrix of a covariance matrix for two probability variables Xb and Xr, and Xb(Y) and Xr(Y) may respectively mean an average of Xb and Xr for a specific Y value. In reference to Equation 2, it is understood that a probability distribution of Cb and Cr elements with regard to a skin color may vary according to a Y value.

However, according to an exemplary embodiment, a color distribution map is not limited to derivation from Equation 2 shown above. For example, with regard to pixels that have a color in the skin color series which is extracted from a face area, a polynomial expression having a chroma element as a variable may be generated. If pixels that satisfy a polynomial expression having a chroma element as a variable are detected as constituting an area, a similar area may be more accurately extracted. However, such a method may be more suitably applied to an image rather than to a video clip in which objects make a lot of motions. In other words, a form of a color distribution map to be applied may be determined in consideration of characteristics of an image.

The probability map generation unit 239 may calculate a probability indicating whether each pixel in the input image will be included in a skin color series using a color distribution map for Cb and Cr elements of a skin color, which is modeled with an associated probability distribution, as shown in Equation 2.

FIG. 4 is a block diagram of the determination unit 250 included in the image quality improvement apparatus according to an exemplary embodiment.

Referring to FIG. 4, the determination unit 250 included in the image quality improvement apparatus 200 may include an area detection unit 255 and a noise removing unit 257.

As shown in FIG. 4, the determination unit 250 included in the image quality improvement apparatus 200 includes only elements related to the current embodiment. However, it will be understood by those skilled in the art that general use elements other than the elements shown in FIG. 4 may be further included in the determination unit 250.

The area detection unit 255 may compare a probability value of respective pixels that are calculated by the probability map generation unit 239 against a preset reference value in order to detect a skin area. In particular, if a probability value of a pixel is equal to or higher than the preset reference value, it may be determined that the pixel is in the first area, and the first area is a skin area. In contrast, if a probability value of a pixel is less than a preset reference value, it may be determined that the pixel is in the second area and that the second area is an area other than the skin area.

The noise removing unit 257 may remove noise in a first area and a second area determined by the area detection unit 255. For example, the noise removing unit 257 may equalize each area in the first area and the second area. Thus, a high-frequency element is reduced. Additionally, the noise removing unit 257 may remove noise in each area using a median filter, a bilateral filter, or using another method such as dilation, erosion, opening or closing of morphology.

Additionally, by blurring the first area and the second area, a boundary effect may be generated during a process of converting the color of each pixel in the input image into a YCbCr space.

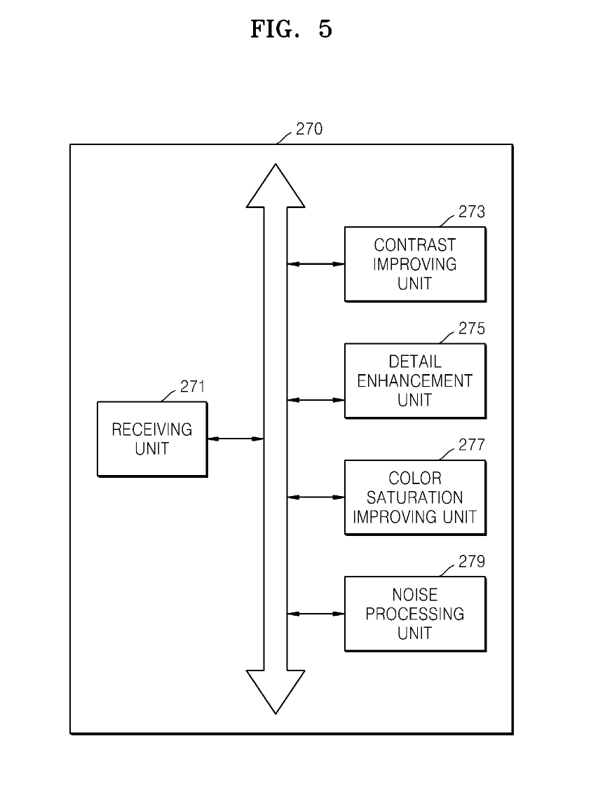

FIG. 5 is a block diagram of the change unit 270 included in the image quality improvement apparatus according to an exemplary embodiment.

Referring to FIG. 5, the change unit 270 included in the image quality improvement apparatus 200 may include a receiving unit 271, a contrast improving unit 273, a detail enhancement unit 275, a color saturation improving unit 277, and a noise processing unit 279.

The receiving unit 271 may receive an input image which is determined as a first area or a second area by the determination unit 250. Additionally, the receiving unit 271 may receive a user input that selects an area of the input image to which a sequential image processing process is to be applied. According to an exemplary embodiment, the image quality improvement apparatus 200 may execute various processes on the selected area of the input image.

According to an exemplary embodiment, the image quality improvement apparatus 200 may process an input image by selecting at least one from among the contrast improving unit 273, the detail enhancement unit 275, the color saturation improving unit 277, and the noise processing unit 279. As an example, by using the color saturation improving unit 277, a color of the first area that is a skin color area is maintained, and a color saturation effect is exerted on the second area. Thus, the color in a skin color area may maintain a natural skin color and a color in areas other than the skin color area may be emphasized.

However, the first area is not limited to a skin color area. A specific color, as well as a skin color, may be modeled using the image quality improvement apparatus 200. Thus, a pixel or an area that has a similar color to the skin color may be clearly identified.

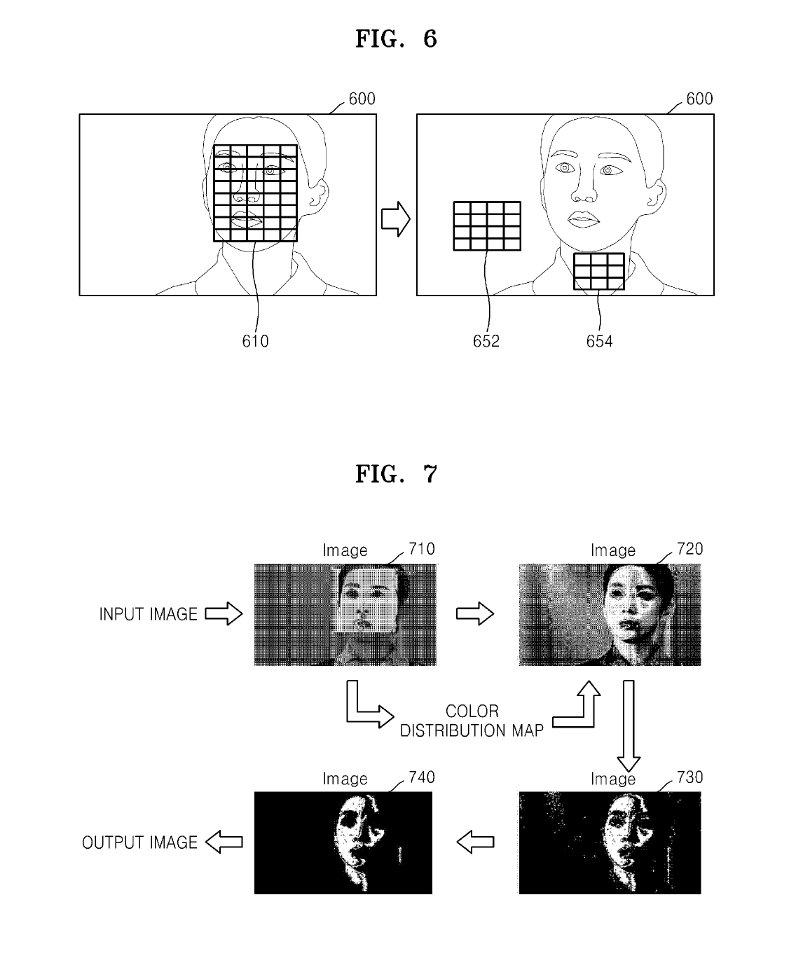

FIG. 6 is a flowchart for explaining a method of detecting a skin color area in an input image according to an exemplary embodiment.

The detection unit 210 may detect a face area 610 from an input image 600. According to an exemplary embodiment, a face detection method is not limited to a specific detection technology. Thus, the face detection method may be executed using a face detection technology with a 2D Haar filter.

The generation unit 230 may generate a color distribution map based on a brightness element and a chroma element of pixels belonging to a specific color series and included in the detected face area 610. The color distribution map may be generated by combining a distribution of a first chroma element with a distribution of a second chroma element respectively according to brightness elements of pixels. In particular, the color distribution map may be generated by combining a distribution of a Cb element according to brightness elements of pixels with a distribution of a Cr element according to brightness elements of pixels.

According to an exemplary embodiment, a plurality of face areas may be detected. If a plurality of face areas are detected, the generation unit 230 may generate respective color distribution maps for each of the plurality of detected face areas based on a brightness element and a chroma element of pixels belonging to a specific color series.

In particular, in a process of generating a color distribution map, if there are two or more face areas, the same number of color distribution maps may be obtained independently in correspondence with the number of face areas, using pixels belonging to a skin color series and which are extracted from each face area. An area in the skin color series in the input image, which is obtained by combining areas that are determined according to a color distribution map which is obtained from each face area, may be determined as a first area. However, this is only an exemplary embodiment, and detection of a plurality of face areas is not limited thereto. According to another exemplary embodiment, skin colors that are respectively extracted from each face area may be combined and modeled into one color distribution map.

The generation unit 230 may generate data which may determine whether each pixel in the input image is included in a color series, based on the generated color distribution map. The data may include a value of probability which indicates whether each pixel in the input image will be included in a skin color series.

The determination unit 250 may determine an area of the input image 600 by comparing a probability value of each pixel to a preset reference value based on the generated color distribution map. For example, if a probability value of a pixel is equal to or higher than a preset reference value, it may be determined that the pixel is in the first area, and the first area is a skin area. In contrast, if a probability value of a pixel is less than a preset reference value, it may be determined that the pixel is in the second area and that the second area is an area other than the skin area.

In the input image 600 shown in FIG. 6, an area 652 may be included in the second area that is an area other than a skin color area. An area 654 may be included in the first area that is a skin color area.

FIG. 7 is a diagram for explaining a process of detecting a skin color area in an input image according to an exemplary embodiment.

Image 710 shows a process in which the detection unit 210 detects a face area in an input image. As an example, the detection unit 210 may detect a face area using a face detection technology with a 2D Haar filter.

Image 720 shows a process of generating probability information regarding the entire image, based on a color distribution map generated based on a brightness element and a chroma element that are extracted from the detected face area.

In particular, the generation unit 230 converts a color element of the extracted pixels into a YCbCr space, which is a color space according to a brightness element and a chroma element. In the YCbCr space, a coordinate of the extracted pixel may be obtained with regard to Cb having a value of Y as a variable (in a Y-Cb plane) and Cr having a value of Y as a variable (in a Y-Cr plane) for a color element of the extracted pixels.

A form in which coordinates of the extracted pixels are distributed in the Y-Cb plane may be expressed as a function in which Y is a variable. Additionally, a form in which coordinates of the extracted pixels are distributed in the Y-Cr plane may be expressed as a function in which Y is a variable.

Image 730 shows a process of determining a first area and a second area with regard to an input image, based on the generated probability information. The determination unit 250 may determine a first area that is included in a skin color series and a second area that is an area other than the first area in the input image, according to the color distribution map.

Image 740 shows a process of generating a clear image by removing noise from the input image that is determined as the first area or the second area.

For example, the determination unit 250 may equalize each area in the first area and the second area. Therefore, a high-frequency element is reduced. Additionally, the noise removing unit 257 may remove noise in each area by using a median filter, a bilateral filter, or using another method such as dilation, erosion, opening or closing of morphology.

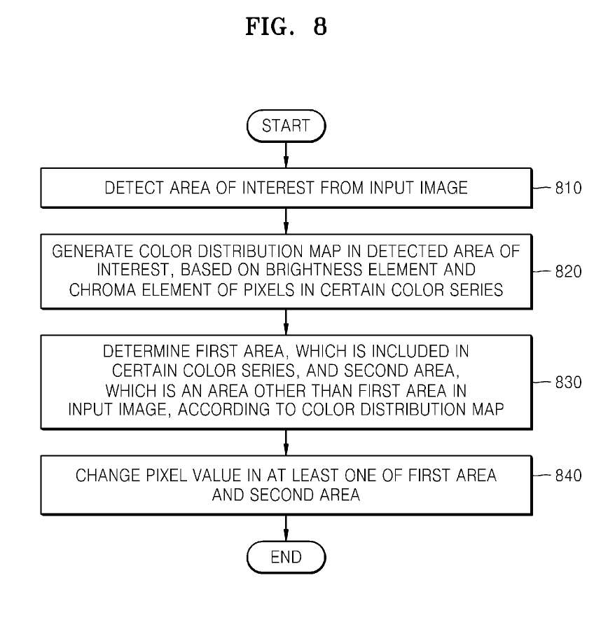

FIG. 8 is a flowchart for explaining the image-quality improvement method according to an exemplary embodiment.

In operation 810, the detection unit 210 may detect the area of interest 115 from the input image 110. The area of interest 115 may include sample pixels for generating a color distribution map according to a certain color series. According to an exemplary embodiment, the area of interest 115 may be a face area of a person.

In operation 820, the generation unit 230 may generate a color distribution map, based on a brightness element and a chroma element belonging to a certain color series, from the detected face area.

In particular, the generation unit 230 may convert a color element of the extracted pixels into a YCbCr space, which is a color space according to a brightness element and a chroma element. In the YCbCr space, a coordinate of the extracted pixel may be obtained, with regard to Cb having a value of Y as a variable (in a Y-Cb plane) and Cr having a value of Y as a variable (in a Y-Cr plane) for a color element of the extracted pixels.

A form in which coordinates of the extracted pixels are distributed in the Y-Cb plane may be expressed as a function in which Y is a variable. Additionally, a form in which coordinates of the extracted pixels are distributed in the Y-Cr plane may be expressed as a function in which Y is a variable. A color distribution map for the extracted pixel may be generated by defining a difference between a function represented in the Y-Cb plane and a function represented in the Y-Cr plane as a new variable.

In operation 830, the determination unit 250 may determine a first area that is included in a skin color series and a second area that is an area other than the first area in the input image, according to the color distribution map.

In operation 840, the change unit 250 may change a value of pixels in at least one of the first area and the second area. With regard to the at least one of the first area and the second area, the change unit 270 may perform at least one process among a process of adjusting a strength of contrast, a process of sharpening an edge by enhancing a detail, a process of adjusting color saturation, and a process of removing noise.

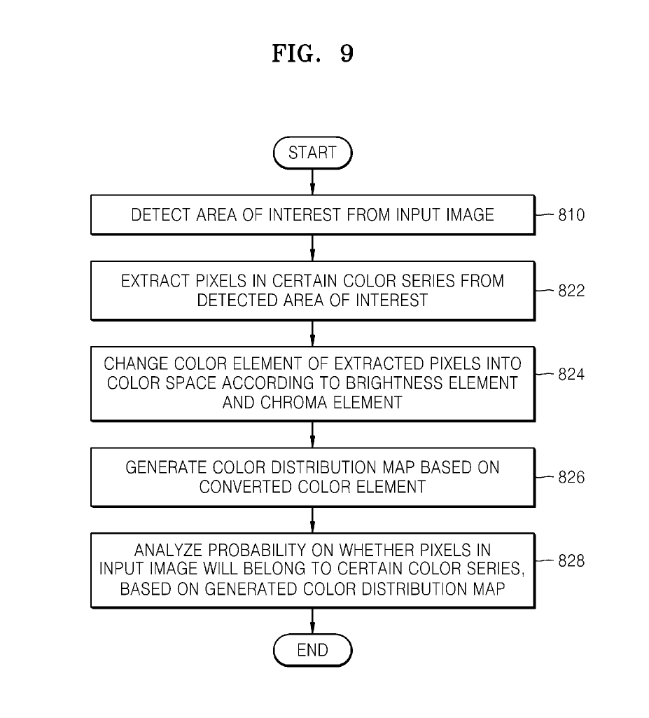

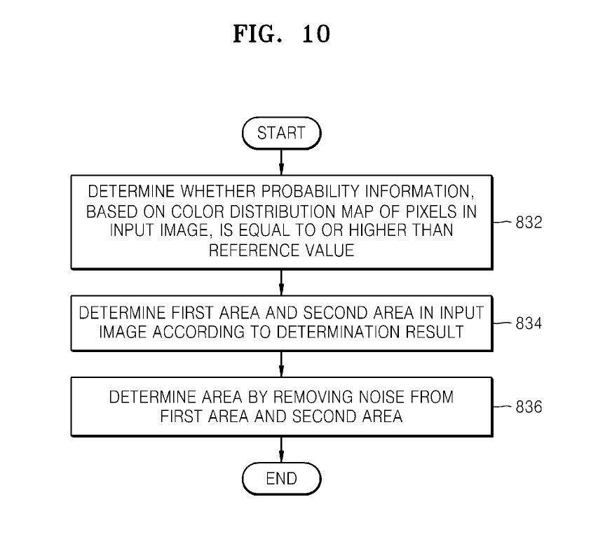

FIG. 9 is a flowchart for explaining generating a color distribution map included in the image-quality improvement method according to an exemplary embodiment.

As in operation 810 of FIG. 9, the detection unit 210 may detect the area of interest 115 from the input image 110. The area of interest 115 may include sample pixels for generating a color distribution map according to a certain color series. According to an exemplary embodiment, the area of interest 115 may be a face area of a person.

In operation 822, the pixel extraction unit 235 may extract pixels belonging to a skin color series from the area of interest 115 that is detected in operation 810.

According to an exemplary embodiment, if the area of interest 115 is a face area, a certain color series may be a pixel in a skin color series. According to an exemplary embodiment, the pixel extraction unit 235 may select a pixel belonging to a series of a defined skin color from a center of a face area and extract pixels that belong to that same skin color series and are distributed in the face area, by applying a flood-fill method to the selected pixel.

A method of extracting pixels is not limited thereto. For example, the pixel extraction unit 235 may extract pixels in the skin color series from the face area that is detected based on a defined skin-color model or a skin color image.

In operation 824, the color distribution map generation unit 237 may convert a color element of the pixels, which are extracted in operation 822, into a YCbCr space, which is a color space according to a brightness element and a chroma element. In the YCbCr space, a coordinate of the extracted pixel may be obtained, with regard to Cb having a value of Y as a variable (in a Y-Cb plane) and Cr having a value of Y as a variable (in a Y-Cr plane) for a color element of the extracted pixels.

A form in which coordinates of the extracted pixels are distributed in the Y-Cb plane may be expressed as a function in which Y is a variable. Additionally, a form in which coordinates of the extracted pixels are distributed in the Y-Cr plane may be expressed as a function in which Y is a variable.

In operation 826, the color distribution map generation unit 237 may define a difference between a function which is represented in the Y-Cb plane and a function which is represented in the Y-Cr plane as a new variable. Therefore, a color distribution map is generated for the extracted pixel. In particular, a probability variable for a difference value of the Cb element in each Y-Cb coordinate, and a probability variable for a difference value of the Cr element in each Y-Cr coordinate are derived. Thus, a probability distribution function may be generated based on the derived probability variable.

In operation 828, the probability map generation unit 239 may calculate a probability indicating whether each pixel of the input image is expected to belong to a skin color series, by using a color distribution map for Cb and Cr elements with regard to Y.

FIG. 10 is a flowchart for explaining determining each area in an input area according to an exemplary embodiment.

In operation 832, the area detection unit 255 may determine whether the probability that is calculated based on the color distribution map for pixels of the input image is equal to or higher than a reference value.

In operation 834, the area detection unit 255 may determine the first area from the second area in the input image, based on a result of the determining in operation 832. In particular, if a probability value of a pixel is equal to or higher than the preset reference value, the pixel may be included in the first area. In contrast, if a probability value of a pixel is less than a preset reference value, the pixel may be included in the second area.

In operation 836, the noise removing unit 257 may remove noise in a first area and a second area which are determined in operation 834. For example, the noise removing unit 257 may equalize each area in the first area and the second area, thus reducing a high-frequency element. Additionally, the noise removing unit 257 may remove noise in each area using a median filter, a bilateral filter, or using another method such as dilation, erosion, opening or closing of morphology.

In addition, other exemplary embodiments may also be implemented through computer readable code/instructions stored in/on a medium, e.g., a computer readable medium, to control at least one processing element to implement any above described embodiment. The medium may correspond to any medium/media permitting the storage and/or transmission of the computer readable code.

The computer readable code may be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more embodiments. The media may also be a distributed network, so that the computer readable code is stored/transferred and executed in a distributed fashion. Furthermore, the processing element could include a processor or a computer processor, and processing elements may be distributed and/or included in a single device

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the exemplary embodiments, reference has been made to the exemplary embodiments illustrated in the drawings, and specific language has been used to describe these embodiments. However, no limitation of the scope of the exemplary embodiments is intended by this specific language, and the exemplary embodiments should be construed to encompass all embodiments that would normally occur to one of ordinary skill in the art.

The exemplary embodiments may be described in terms of functional block components and various processing steps. Such functional blocks may be realized by any number of hardware and/or software components configured to perform the specified functions. For example, the exemplary embodiments may employ various integrated circuit components, e.g., memory elements, processing elements, logic elements, look-up tables, and the like, which may carry out a variety of functions under the control of one or more microprocessors or other control devices. Similarly, where the elements are implemented using software programming or software elements the exemplary embodiments may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the exemplary embodiments could employ any number of techniques for electronics configuration, signal processing and/or control, data processing and the like. The words “mechanism” and “element” are used broadly and are not limited to mechanical or physical embodiments, but may include software routines in conjunction with processors, etc.

The particular implementations shown and described herein are illustrative examples of the exemplary embodiments and are not intended to otherwise limit the scope of the exemplary embodiments in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the exemplary embodiments (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Additionally, it will be understood by those of ordinary skill in the art that various modifications, combinations, and changes may be formed according to design conditions and factors within the scope of the attached claims or the equivalents.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the present invention as defined by the following claims.

What is claimed is:

1. An image quality improvement method, comprising:
detecting an area of interest from an input image;
generating a color distribution map based on a plurality of respective brightness elements and a plurality of respective chroma elements of a plurality of pixels which belong to a predetermined color series and which are in the detected area of interest of the input image;
determining a first area, which belongs to the predetermined color series, and a second area, which is an area of the input image other than the first area, according to the color distribution map; and
changing values of a plurality of pixels in at least one of the first area and the second area.

2. The image quality improvement method of claim 1, wherein the color distribution map is generated based on a distribution of a first chroma element with regard to the respective brightness elements of the plurality of pixels and a distribution of a second chroma element with regard to the respective brightness elements of the respective pixels.

3. The image quality improvement method of claim 2, wherein the color distribution map is determined according to a difference value between the first chroma element and the second chroma element,
wherein the difference value is estimated based on a distribution of the first chroma element with regard to the respective brightness elements, and a plurality of actual chroma elements.

4. The image quality improvement method of claim 1, wherein the generating comprises generating probability information based on the color distribution map,
wherein the probability information comprises a probability of whether a color of the respective pixels in the input image will be included in the predetermined color series.

5. The image quality improvement method of claim 4, wherein the determining is performed by determining a pixel having a probability information value which is equal to or higher than a preset reference value as included in the first area, and determining the pixel having the probability information value which is less than a preset reference value as included in the second area.

6. The image quality improvement method of claim 1, wherein the determining comprises reducing a high frequency element by equalizing each of the first area and the second area.

7. The image quality improvement method of claim 1, wherein the changing is performed by performing at least one from among adjusting a strength of contrast, sharpening an edge, adjusting color saturation, and removing noise, with regard to at least one of the first area and the second area.

8. The image quality improvement method of claim 1, wherein the area of interest is a face area.

9. The image quality improvement method of claim 1, wherein the generating comprises generating respective color distribution maps based on the respective brightness elements and the plurality of respective chroma elements of the pixels which belong to the predetermined color series for each of a plurality of detected areas of interest in response to detecting a plurality of areas of interest.

10. An image quality improvement apparatus, comprising:
a detector which is configured to detect an area of interest from an input image;
a generator which is configured to generate a color distribution map based on a plurality of respective brightness elements and a plurality of respective chroma elements of a plurality of pixels which belong to a predetermined color series and which are in the detected area of interest of the input image;
a determinator which is configured to determine a first area, which belongs to the predetermined color series, and a second area, which is an area of the input image other than the first area, according to the color distribution map; and
a changer which is configured to change values of a plurality of pixels in at least one of the first area and the second area.

11. The image quality improvement apparatus of claim 10, wherein the color distribution map is generated based on a distribution of a first chroma element with regard to the respective brightness elements of the pixels and a distribution of a second chroma element with regard to the respective brightness elements of the pixels.

12. The image quality improvement apparatus of claim 11, wherein the color distribution map is determined according to a difference value between the first chroma element and the second chroma element,
wherein the difference value is estimated based on a distribution of the first chroma element with regard to the respective brightness elements, and a plurality of actual chroma elements.

13. The image quality improvement apparatus of claim 10, wherein the generator is further configured to generate probability information, based on the color distribution map,
wherein the probability information comprises a probability of whether a color of the respective pixels belonging to the input image will be included in the predetermined color series.

14. The image quality improvement apparatus of claim 13, wherein the determinator is further configured to determine a pixel having a probability information value which is equal to or higher than a preset reference value as included in the first area, and determine the pixel having the probability information value which is less than a preset reference value as included in the second area.

15. The image quality improvement apparatus of claim 10, wherein the determinator is further configured to reduce a high frequency element by equalizing each of the first area and the second area.

16. The image quality improvement apparatus of claim 10, wherein the changer is further configured to at least one from among adjust a strength of contrast, sharpen an edge, adjust color saturation, and remove noise, with regard to at least one of the first area and the second area.

17. The image quality improvement apparatus of claim 10, wherein the area of interest is a face area.

18. The image quality improvement apparatus of claim 10, wherein, the generator is further configured to generate respective color distribution maps based on the respective brightness elements and the plurality of respective chroma elements of the pixels which belong to the predetermined color series for each of a plurality of detected areas of interest in response to detecting a plurality of areas of interest.

19. A non-transitory computer-readable medium having stored thereon a computer program, which when executed by a computer, performs:
detecting an area of interest from an input image;
generating a color distribution map based on a plurality of respective brightness elements and a plurality of respective chroma elements of a plurality of pixels which belong to a predetermined color series and which are in the detected area of interest of the input image;
determining a first area, which belongs to the predetermined color series, and a second area, which is an area of the input image other than the first area, according to the color distribution map; and
changing values of a plurality of pixels in at least one of the first area and the second area.
